(19) United States
(12) Patent Application Publication
(10) Pub. No.: US 2023/0062166 A1
(43) Pub. Date: Mar. 2, 2023

(54) Truck bed accessory mounting panels

(71) Applicant: BuiltRight Industries LLC, Brookfield, CT (US)

(72) Inventor: Matt Beenen, Ridgefield, CT (US)

(73) Assignee: BuiltRight Industries LLC, Brookfield, CT (US)

(21) Appl. No.: 18/047,017

(22) Filed: Oct. 17, 2022

Related U.S. Application Data
(63) Continuation-in-part of application No. 17/151,472, filed on Jan. 18, 2021.
Application No. 17/151,472 is a continuation of application No. 16/140,223, filed on Sep. 24, 2018, now Pat. No. 10,933,796.
(60) Provisional application No. 62/561,774, filed on Sep. 22, 2017.

(51) Int. Cl. B60P 7/08; B62D 33/023; B60R 9/02; B60R 9/06; B62D 33/02; B60R 5/00; B60R 7/00; B60R 5/04; B60P 3/00; B60R 7/02; B60R 9/00; B65D 90/00; B60N 2/22

(52) U.S. Cl. CPC B60P 7/0807; B62D 33/023; B60R 9/02; B60R 9/06; B62D 33/0207; B60R 5/00; B60R 7/00; B60R 5/04; B60P 3/007; B60R 7/02; B60R 9/00; B60R 9/065; B65D 90/0053; B60N 2/2245

(57) ABSTRACT

An accessory mounting system is easily coupled to an inner portion of a pick-up bed, thus allowing a user to easily mount and hold equipment. The mounting system includes a number of panels which can be mounted to existing structures within the pick-up box, and which have a pattern of openings to accommodate straps, brackets, tie-downs, and other holding mechanisms.

### CROSS REFERENCES AND PRIORITIES

This application claims priority from U.S. application Ser. No. 17/151,472 filed on 18 Jan. 2021, U.S. application Ser. No. 16/140,223 filed on 24 Sep. 2018, and U.S. Provisional Application No. 62/561,774 filed on 22 Sep. 2017, the teachings of each of which are incorporated by reference herein in their entirety.

### BACKGROUND

The present invention is a panel system that attaches to the bed walls of a pickup truck and facilitate the mounting of accessories. In particular, the embodiments disclosed accommodate mounting of such panels without modification to the vehicle and provide considerable utility to the truck owner.

As is well known, the storage of accessories, tools and more within the box of a truck (e.g. pick-up truck, etc.) is a continuous challenge. This challenge has many facets, including where to put tools or accessories, and how to hold them in place. Balancing these challenges with the efficient use of truck space provides many trade-offs. One prior approach to this challenge is the addition of large tool boxes mounted towards the front of the pickup truck bed to store tools and accessories. Alternatively, these tool boxes could be situated within the truck bed at any location. Unfortunately, this occupies important bed space, leaving the bed shorter or smaller, and significantly less useful.

As another solution, nets/straps cooperating with several tie-downs has been used to hold tools in place. While this is effective, it often requires multiple straps, and the tie-downs are not always conveniently located.

These solutions are often difficult to use, and do not provide useful resources for the user. They also fail to provide the user a method of securing individual items, as to prevent movement, damage and noise. It would be beneficial to have a mechanism for storing and organizing items which is easy to use, adaptable, and flexible.

### SUMMARY

Disclosed herein is a pickup truck bed storage system. The pickup truck bed storage system comprises a substantially planar mounting panel and at least one mounting structure.

The substantially planar mounting panel has an exterior surface and an interior surface opposite the exterior surface. The substantially planar mounting panel further comprises a plurality of holes and at least one mounting hole. Each hole of the plurality of holes passes from the exterior surface through the interior surface. Each mounting hole passes from the exterior surface through the interior surface and has a first radial dimension.

Each mounting structure of the at least one mounting structure comprises a fastener and a spacer. The fastener has a second radial dimension. Each fastener is capable of passing through a mounting hole of the at least one mounting hole and the spacer. Each fastener is configured to connect to a truck bed wall mount.

In some embodiments, the mounting structure may further comprise a washer. In such embodiments, the spacer may comprise a recessed bottom surface. The washer may be configured to interact with the recessed bottom surface. In such embodiments, the fastener may be capable of passing through the washer.

In certain embodiments, the pickup truck bed storage system may further comprise at least one strap. The at least one strap may be configured to interact with at least the plurality of holes of the substantially planar mounting panel.

In some embodiments, the wall of the pickup truck bed may be a side wall. In other embodiments, the wall of the pickup truck bed may be a front wall.

In certain embodiment, the substantially planar mounting panel may further comprise a plurality of slots. In such embodiments, each slot of the plurality of slots may pass from the exterior surface through the interior surface.

In some embodiments, a first measured dimension of the first radial dimension of each mounting hole may be greater than a second measured dimension of the second radial dimension of a corresponding fastener. In certain such embodiments, the first measured dimension may be in a range selected from the group consisting of at least 1.0% greater than the second measured dimension, at least 2.5% greater than the second measured dimension, at least 5.0% greater than the second measured dimension, and at least 10% greater than the second measured dimension.

### BRIEF DESCRIPTION OF FIGURES

Various objects and advantages of the embodiments of the invention can be seen from the following detailed description in conjunction with the drawings, in which:

FIG. 1 is a perspective view or a pick-up truck bed showing a bedside rack system installed therein;

FIG. 2 is a front view of the bedside rack system installed on one side of a pick-up truck bed;

FIG. 3 is a front view of the bedside rack system installed on an opposite side of a pickup truck bed;

FIG. 4 shows a perspective view of a rear bedside panel alone;

FIG. 5 is a top view of the rear bedside panel;

FIG. 6 illustrates a bedside panel with an alternative mounting structure; and

FIG. 7 illustrates a bedside panel with a strap.

FIG. 8 is a perspective view of an alternative embodiment of a bedside rack system.

FIG. 9 is an exploded view of the alternative embodiment of a bedside rack system.

FIG. 10 is a top assembled view of the alternative embodiment of a bedside rack system on a front wall of a pickup truck bed.

### DETAILED DESCRIPTION

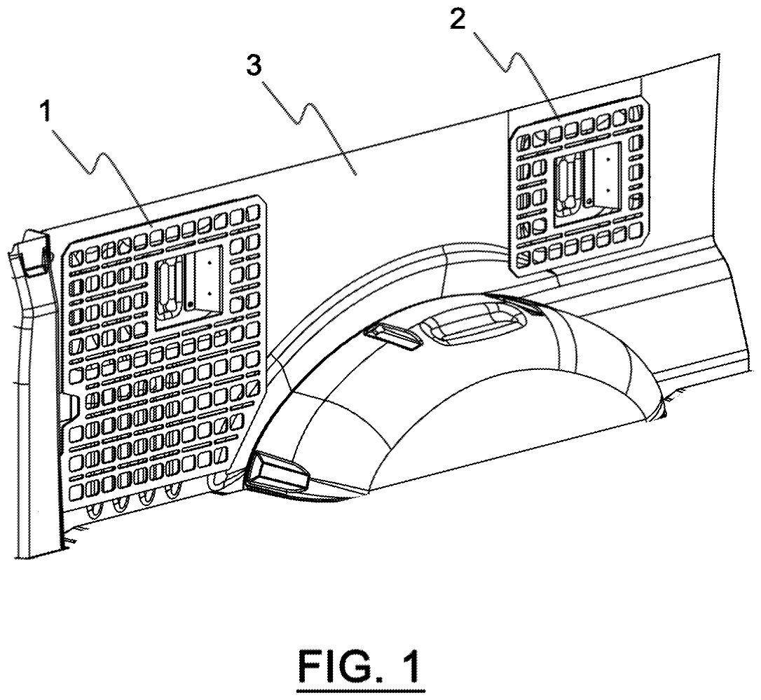

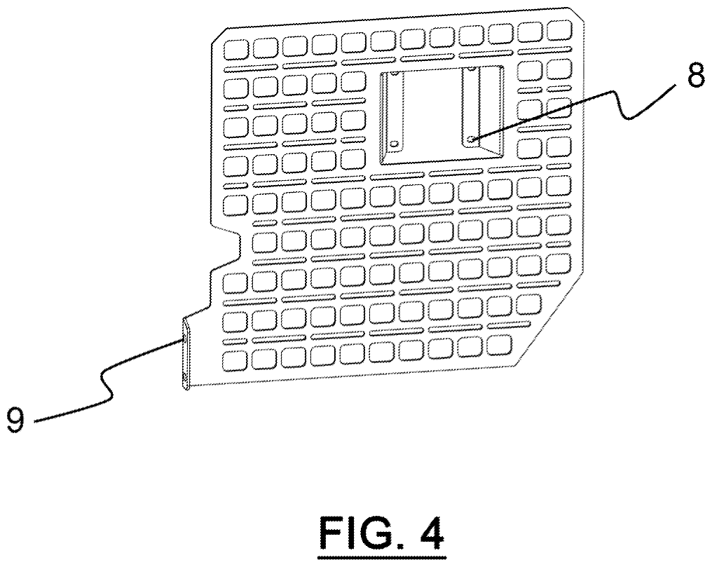

Referring now to FIG. 1, a rear bedside panel 1 and a front bedside panel 2 are illustrated as typically installed on the driver's side of the vehicle. In this case both front bedside panel 2 and rear bedside panel 1 are mounted on the driver's side of the vehicle. As illustrated in the embodiment shown, the rear bedside panel 1 is installed using six bolts and existing mounting points in the truck bed. More specifically, four bolts are coupled to a set of mounting holes 8 (commonly referred to as BoxLink® mounting holes and shown in FIG. 4) and two of the bolts are coupled to a set of tie down mounting holes 9. Similarly, front bedside panel 2 is installed using four bolts coupled to the Boxlink® mounting holes 8. The illustrated embodiment is designed to efficiently fit in the truck bed of Ford F-150 line of pick-up trucks (including Raptor® models). That said, and as further outlined below, modifications could be easily incorporated which allow the device to be applied to many different makes and models of trucks where the bedside rack system can benefit the user.

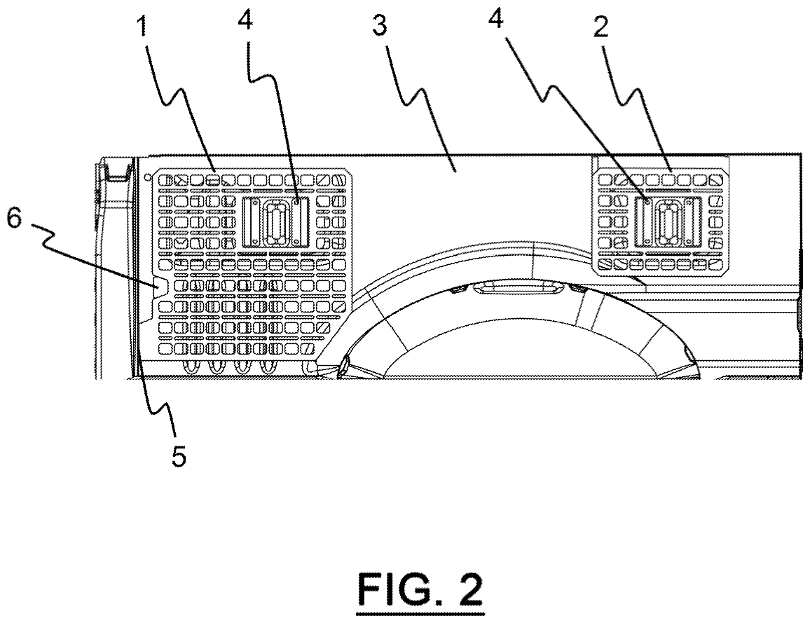

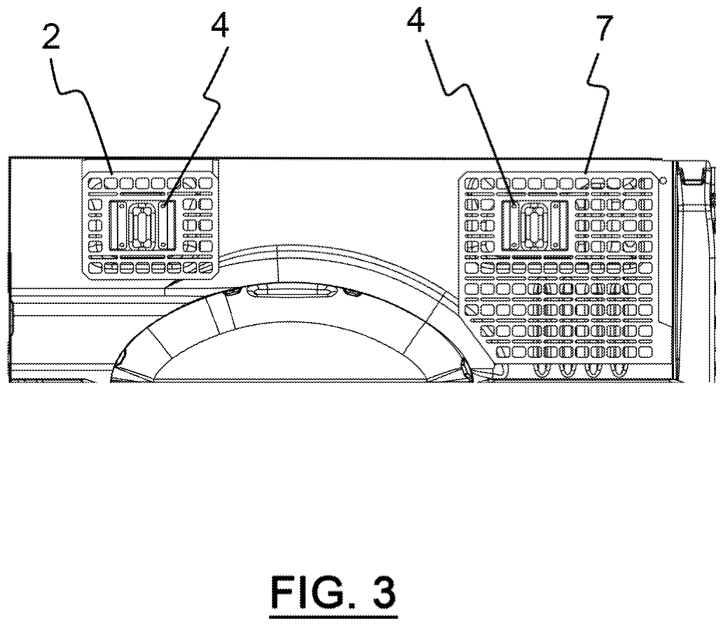

FIG. 2 shows an alternate view of rear bedside panel 1 and front bedside panel 2, while also illustrating a bed light switch clearance feature 6 that is incorporated therein. As will be recognized, FIG. 3 shows the passenger side a truck bed, better illustrating both rear bedside panel 1 and front bedside panel 2 mounted to the passenger side of the truck bed. The passenger side is substantially similar, except for the bed light switch clearance feature 6 being a mirror image of the driver's side.

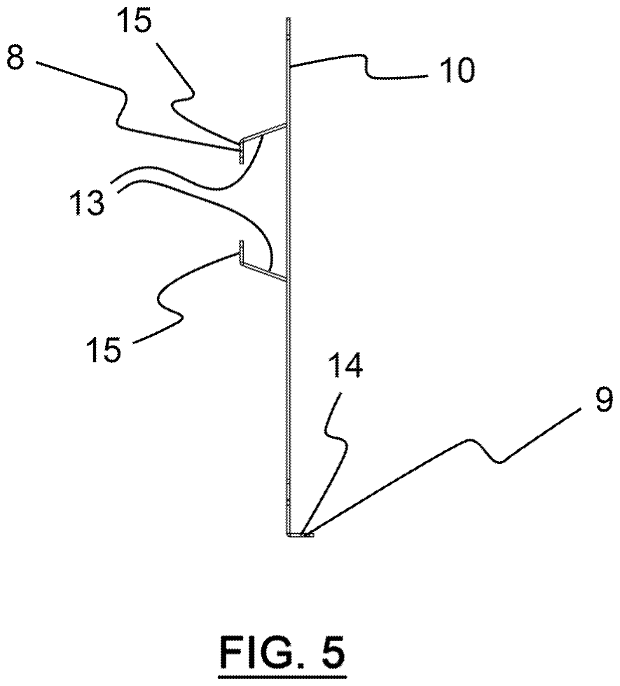

In operation one uses the panels as a means of mounting clamps or other devices intended to attach or secure accessories within the pickup bed. Each panel has a substantially planar main panel portion 10, which has a number of slots 11 and/or holes 12. In many circumstance, a predetermined pattern of slots and/or openings is used, thus providing many options for a user. A number of mounting extensions are also included, which can provide the above mentioned attachment to the truck. As best illustrated in FIG. 5, one embodiment of the mounting structure includes at least one pair of inwardly angled tabs 13 which extend from portions of main panel portion 10. These inwardly angled tabs 13 are configured to have Boxlink® mounting holes 8 contained in a lip portion 15. As can be seen, these structures are easily formed by bending certain portions of the main panel portion 10 inwardly. As will be appreciated, these type of attachment features are easily formed during a manufacturing process. In addition, a bottom lip member 14 also extends from main panel member 10. Bottom lip member 14 is configured to support the above mentioned tie down mounting holes 9, thus further accommodating mounting mechanism (i.e. mounting bolts).

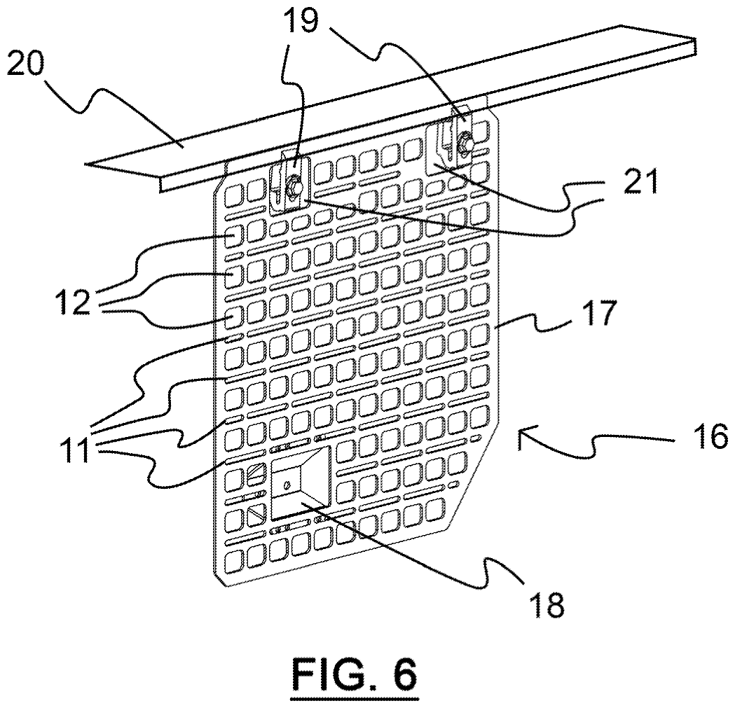

Naturally, other mounting structures could be used. For example, a stand-off could be formed to allow mounting to the Boxlink® mounting structures within the pick-up box, while also maintaining separation between main panel member 10 and the side portions of the pick-up truck. In yet a further example, FIG. 6 shows another embodiment of an accessory mounting panel 16. In this embodiment, mounting panel 16 includes a main panel portion 17 which supports a plurality of slots 11 and holes 12. In addition, a separate lower mounting bracket 18 is included, along with a pair of mounting brackets 19. Here, mounting brackets 19 are used to couple main panel member 17 with an upper lip 20 of the pick-up truck. As shown, mounting brackets 19 are U-Shaped, and are inserted into a related pair of openings 21 which exist in main panel portion 17. In this manner, main panel portion 17 can be securely held in position to accommodate operation. Again, variations of this approach could be used, with alternative brackets potentially cooperating with existing holes 12.

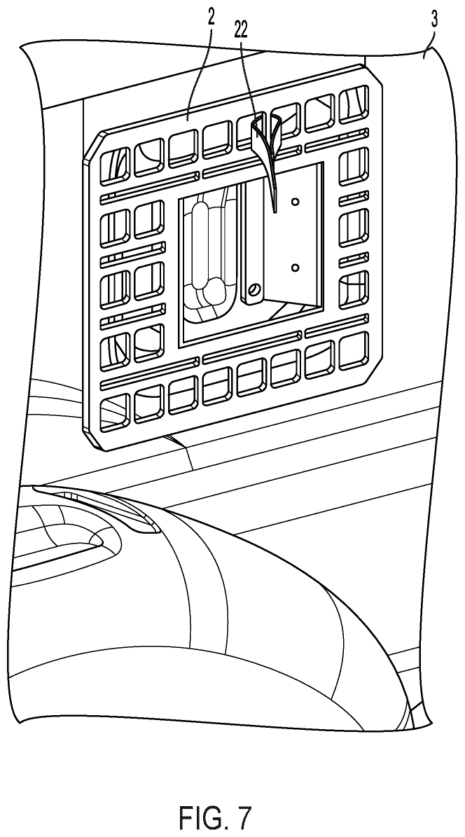

In the illustrated embodiment, the mounting hole pattern is modeled after the military standard of MOLLE and PALS gear. The larger holes are sized and spaced to accept military MOLLE standard pouches and other attachments. The smaller holes and slots are sized and spaced to allow maximum adjustment when mounting other clamps, tie-down hooks and accessories. A series of attachments, designed specifically to interface with these panels can be used with the panels discussed above. In addition, the slots are of a size that is compatible with readily available hardware, straps ((22) as shown in FIG. 7), many clamps and device holders, thus making the system very adaptable and compatible. For example, users may mount small rubber clamps to secure a hammer or flashlight and may also mount larger rubber clamps to secure a fire extinguisher. Other clamps or brackets may be used to hold gas tanks, propane tanks, air tanks safely in place. Many tool and gear manufacturers offer their product, such as a floor jack, with a universal mounting bracket. This series of panels is meant to provide a mounting location for many different devices without requiring drilling or modification of the user's vehicle.

It is noted that other embodiments may combine both rear panel 1 and front panel 2 into a single larger panel. Some of additional embodiments may also offer an additional panel section, to connect the other two panels and form a continuous planar surface. Further embodiments may replace a single panel with two pieces—the first to act as a mounting bracket for the panel and the second to act as the panel itself. This provides a user with a small amount of flexibility during installation, to accommodate other possible modifications to the vehicle.

Yet another embodiment would use the upper lip of the bed and the other surfaces of the bed to brace against and create a rigid mounting solution in the absence of useable threaded features. The panels may be secured to the upper lip using a clamp or series of clamps (as discussed above in relation to FIG. 6) while the user may, at their own discretion, choose to drill and bolt as an alternate means of attachment to the upper lip. In the absence of useable threaded features, the system may also include the use of threaded inserts, to be installed by the user into the surfaces of the bed, using a hole drilled in the truck.

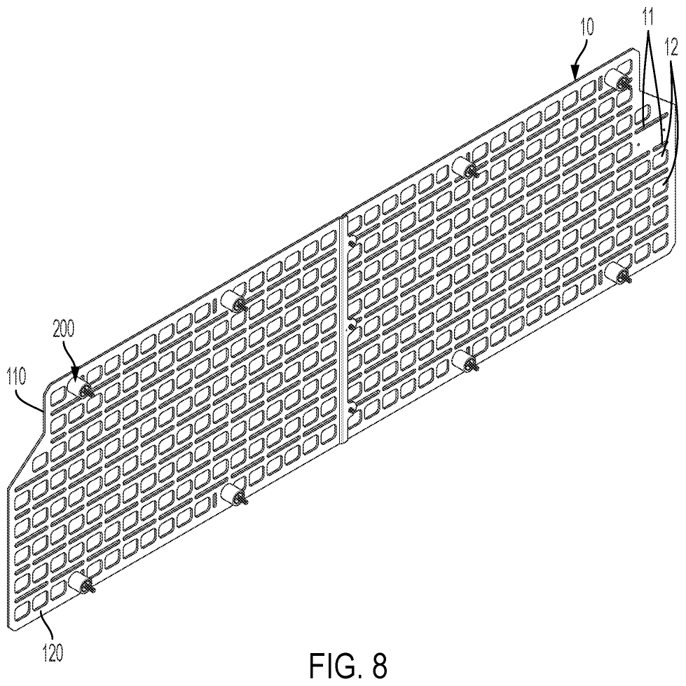

FIG. 8 shows an alternative embodiment of a pickup truck bed storage system. As in the embodiments shown in FIG. 1 through FIG. 7, the embodiment of a pickup truck bed storage system in FIG. 8 comprises a substantially planar mounting panel (10). The substantially planar mounting panel has an exterior surface (110) and an interior surface (120) opposite the exterior surface.

Passing from the exterior surface (110) through the interior surface (120) are a plurality of slots (11) and a plurality of holes (12) as described herein with reference to FIG. 1 through FIG. 7. Further passing from the exterior surface through the interior surface in the alternative embodiment is at least one mounting hole (130). Each mounting hole of the at least one mounting hole will have a first radial dimension having a first measured dimension.

The embodiment of a pickup truck bed storage system shown in FIG. 8 further comprises at least one mounting structure (200). Each mounting structure of the at least one mounting structure comprises at least a fastener (210) and a spacer (220). The preferred embodiment of a fastener is a bolt, although alternative embodiments such as a screw, a rivet, a pin, or the like may be utilized. In any event, the fastener will have a second radial dimension having a second measured dimension.

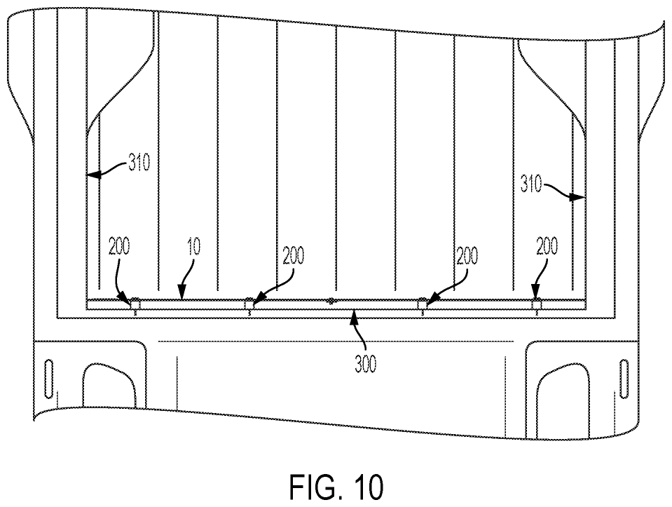

The first measured dimension of the first radial dimension of each mounting hole (130) will be in a range selected from the group consisting of at least 1.0% greater than, at least 2.5% greater than, at least 5.0% greater than, and at least 10% greater than the second measured dimension of the second radial dimension of a corresponding fastener (210). This greater measured dimension allows the fasteners to pass through the mounting holes, through the spacers (220), and into corresponding mounts on a wall of a pickup truck bed (as shown in FIG. 10) with sufficient adaptability to account for slight variances in the spacing and dimension of the preexisting mounts in the wall of the pickup truck bed.

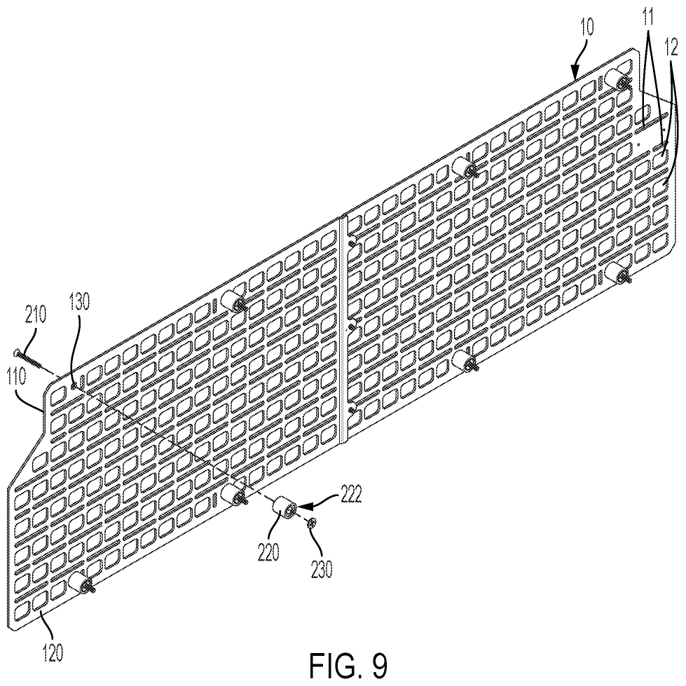

FIG. 9 shows an exploded perspective view of the substantially planar mounting panel (10) and mounting structure (200) of the alternative embodiment shown in FIG. 8. As seen in FIG. 9, in some embodiments, the mounting structure may further comprise a washer (230). In such embodiments, the spacer (220) may comprise a recessed bottom surface (222) with the washer configured to interact with the recessed bottom surface. The fastener may then pass through the washer—in addition to passing through the mounting holes (130) and spacers (220)—before passing into the preexisting mounts on the wall of the pickup truck bed.

FIG. 10 shows a top view of the alternative embodiment of a pickup truck bed storage system shown in FIG. 8 installed on a wall of a pickup truck bed. In FIG. 10, the wall of the pickup truck bed is a front wall (300). However, embodiments, may exist in which the wall of the pickup truck bed is a side wall (310). In general, the wall of the pickup truck bed may comprise a plurality of truck bed wall mounts. These may be existing, factory installed truck bed wall mounts arranged in a predefined pattern. The location of the mounting holes (130 as shown in FIG. 9) in the substantially planar mounting panel should generally correspond to the location of the existing, factory installed mounts to allow the fasteners to pass through the mounting holes, through the spacers (220), through the (optional) washers (230), and into the truck bed wall mounts thereby securely connecting the pickup truck bed storage system to the wall of the pickup truck bed.

Another embodiment would use unthreaded features in the bed of a truck, such as the GMC Sierra® and Chevrolet Silverado®, as mounting locations. A bracket may be manufactured using sheet metal, CNC machining or casting, that attached to an unthreaded feature or hole and provides a threaded mounting location. The bracket described would be inserted into the hole and then secured using hardware that braces against the inaccessible side of the panel, pinching the panel for strength. This bracket may also provide additional unthreaded features that a panel can be attached to.

Although the above mechanism has been described as a fitting the Ford F-150 (including Raptor® models), modifications could be easily incorporated which allow the device to be applied to many different makes and models of trucks where the Bedside Rack System can benefit the user. These makes and models include, but are not limited to, the Ford Super Duty®, Ford Ranger®, Chevy Silverado®, GMC Sierra®, Toyota Tundra®, Toyota Tacoma® and Dodge Ram®. More significantly, the above embodiments of the Bedside Rack System can be made to easy fit many vehicle models without significant rework.

The system may also be modified to fit into the rear cargo area of a Sport Utility Vehicle using the threaded mounting points typically available.

Various embodiments of the invention have been described above for purposes of illustrating the details thereof and to enable one of ordinary skill in the art to make and use the invention. The details and features of the disclosed embodiments are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

What is claimed is:

1. A pickup truck bed storage system comprising:
a substantially planar mounting panel having an exterior surface and an interior surface opposite the exterior surface, said substantially planar mounting panel comprising:
a plurality of holes with each hole passing from the exterior surface through the interior surface, and
at least one mounting hole with each mounting hole passing from the exterior surface through the interior surface and having a first radial dimension; and
at least one mounting structure, each mounting structure comprising a fastener and a spacer, said fastener having a second radial dimension; and
wherein each fastener is capable of passing through a mounting hole of the at least one mounting hole and the spacer, and is configured to connect to a truck bed wall mount.

2. The pickup truck bed storage system of claim 1, wherein the mounting structure further comprises a washer, the spacer comprises a recessed bottom surface, the washer is configured to interact with the recessed bottom surface, and the fastener is capable of passing through the washer.

3. The pickup truck bed storage system of claim 1, further comprising at least one strap configured to interact with at least one of the plurality of holes of the substantially planar mounting panel.

4. The pickup truck bed storage system of claim 2, further comprising at least one strap configured to interact with at least one of the plurality of holes of the substantially planar mounting panel.

5. The pickup truck bed storage system of claim 1, wherein the wall of the pickup truck bed is a side wall.

6. The pickup truck bed storage system of claim 2, wherein the wall of the pickup truck bed is a side wall.

7. The pickup truck bed storage system of claim 3, wherein the wall of the pickup truck bed is a side wall.

8. The pickup truck bed storage system of claim 4, wherein the wall of the pickup truck bed is a side wall.

9. The pickup truck bed storage system of claim 1, wherein the wall of the pickup truck bed is a front wall.

10. The pickup truck bed storage system of claim 2, wherein the wall of the pickup truck bed is a front wall.

11. The pickup truck bed storage system of claim 3, wherein the wall of the pickup truck bed is a front wall.

12. The pickup truck bed storage system of claim 4, wherein the wall of the pickup truck bed is a front wall.

13. The pickup truck bed storage system of claim 1, wherein the substantially planar mounting panel further comprises a plurality of slots with each slot passing from the exterior surface through the interior surface.

14. The pickup truck bed storage system of claim 1, wherein a first measured dimension of the first radial dimension of each mounting hole is greater than a second measured dimension of the second radial dimension of a corresponding fastener.

15. The pickup truck bed storage system of claim 14, wherein the first measured dimension is in a range selected from the group consisting of at least 1.0% greater than the second measured dimension, at least 2.5% greater than the second measured dimension, at least 5.0% greater than the second measured dimension, and at least 10% greater than the second measured dimension.

16. The pickup truck bed storage system of claim 2, wherein a first measured dimension of the first radial dimension of each mounting hole is greater than a second measured dimension of the second radial dimension of a corresponding fastener.

17. The pickup truck bed storage system of claim 16, wherein the first measured dimension is in a range selected from the group consisting of at least 1.0% greater than the second measured dimension, at least 2.5% greater than the second measured dimension, at least 5.0% greater than the second measured dimension, and at least 10% greater than the second measured dimension.

18. The pickup truck bed storage system of claim 3, wherein the substantially planar mounting panel further comprises a plurality of slots with each slot passing from the exterior surface through the interior surface, and the at least one strap is configured to interact with at least one of the plurality of slots.

19. The pickup truck bed storage system of claim 4, wherein the substantially planar mounting panel further comprises a plurality of slots with each slot passing from the exterior surface through the interior surface, and the at least one strap is configured to interact with at least one of the plurality of slots.
